(19) United States
(12) Patent Application Publication
(10) Pub. No.: US 2003/0172811 A1
(43) Pub. Date: Sep. 18, 2003

(54) Air stream skimmer

(76) Inventor: Shane Johnson, Lubbock, TX (US)

Correspondence Address: Aaron R. Clements, Hurley, Reyes & Guinn, 1805-13th Street, Lubbock, TX, 79401, US

(21) Appl. No.: 10/099,046

(22) Filed: Mar. 14, 2002

(51) Int. Cl. B01D 45/12

(52) U.S. Cl. 95/271; 55/459.1

(57) ABSTRACT

A method and apparatus for separating particulate matter from an air stream is disclosed in which an air stream is passed into a chamber defining a curved path and over a baffle located within the chamber. The baffle separates the air stream, skimming off the particulate matter and allowing it to fall into an airlock for collection while the air stream is vented into the outside environment.

### CROSS REFERENCE TO RELATED APPLICATIONS

Not Applicable.

### STATEMENT REGARDING FEDERALLY SPONSORED RESEARCH

Not Applicable.

### REFERENCE TO “MICROFICHE APPENDIX”

Not Applicable.

### BACKGROUND OF THE INVENTION

The present Invention is directed towards a method and device for separating particulate matter from an air stream.

Use of suction to pick up material is highly desirable because of the relatively high efficiency and low labor requirements of such methods. These methods involve introducing material into an air stream and then later separating the material from the air stream and depositing the material into some form of storage hopper. In addition to the desired material, which can range from a wide variety of agricultural products to litter, these methods pick up a substantial amount of dust and other small particulate matter. Due to increasing environmental regulations and more stringent air quality standards, a problem exists with devices that fail to separate this particulate matter from the air stream before venting the air stream back into the local environment.

A number of methods have previously been used to accomplish this separation of particulate matter from the accompanying air stream. A variety of in-line filters and secondary filtration systems have attempted to accomplish this separation. However, these devices tend to be relatively inefficient, either requiring secondary fan systems (thereby compromising both the economy and efficiency of the overall collection and separation system) or have a narrow range limit on the size of matter which can be separated. These devices are also maintenance-intensive, compounding the problems of economy and efficiency.

In addition to these systems, cyclones have arisen as a standard method of separating particulate matter of a wide variety of sizes from an air stream. Cyclones function by introducing the air stream tangentially along the top and outside of a large funnel. The air stream then forms an outer vortex as it descends through the cyclone, followed by an inner vortex as the air stream reverses direction at the bottom of the vortex. Particulate matter leaves the air stream at the point of reversal, and the inner vortex vents the air stream out through the top of the cyclone. Such systems have been preferred over other separation systems due to their low maintenance costs and ease of operation. Cyclones contain no moving parts and rely on the primary air stream, operating without the need for secondary fans or filtration systems.

While the theory of operation and construction of cyclones has become extremely refined, they suffer from some fundamental limitations. The size of particulate matter which can be separated with a cyclone is directly dependent on the size of the cyclone itself, with larger cyclones needed to separate smaller particulate matter. Because of this relationship between the size of the cyclone to the size of particles which can be separated, cyclones have limited portability and cannot easily be incorporated into a vehicular system for picking up material. A need exists, therefore, for a much more compact, higher efficiency separation system which, like a cyclone, contains no moving parts and is therefore easy to maintain.

### SUMMARY OF THE INVENTION

The present Invention solves the difficulties inherent in cyclones and other methods of particulate separation by utilizing the momentum of the particulate matter in an air stream to separate that matter from the air stream. An enclosure is provided at the end of a horizontal air stream which allows particulate matter to continue on its course, while also providing a vent out for the air stream such that the stream changes directions within the enclosure. The particulate matter is thus separated from the air stream. The enclosure needed to accomplish this separation is substantially smaller than current cyclone designs, thereby allowing for portability. Because this system does not rely on generating a vortex within the enclosure, higher air stream velocities can be attained with lower power motors, thus improving both the efficiency and capability of the overall gathering device. These and other features, aspects, and advantages of the present invention will become better understood with reference to the following description and appended claims.

### DESCRIPTION OF THE DRAWINGS

FIG. 1 is a side view of the skimmer and related components with a breakaway view of the side. Arrows represent airflow through the device.

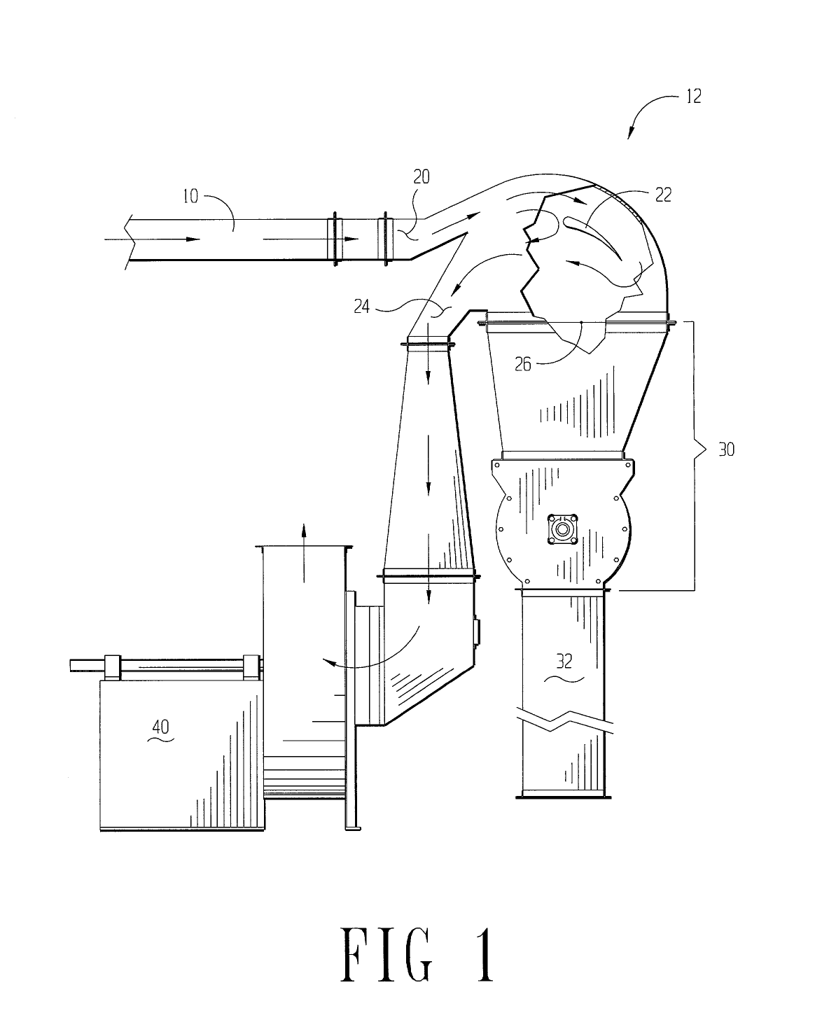

FIG. 2 is a breakaway view of the skimmer showing air and particulate flow through the skimmer. Arrows represent airflow through the device.

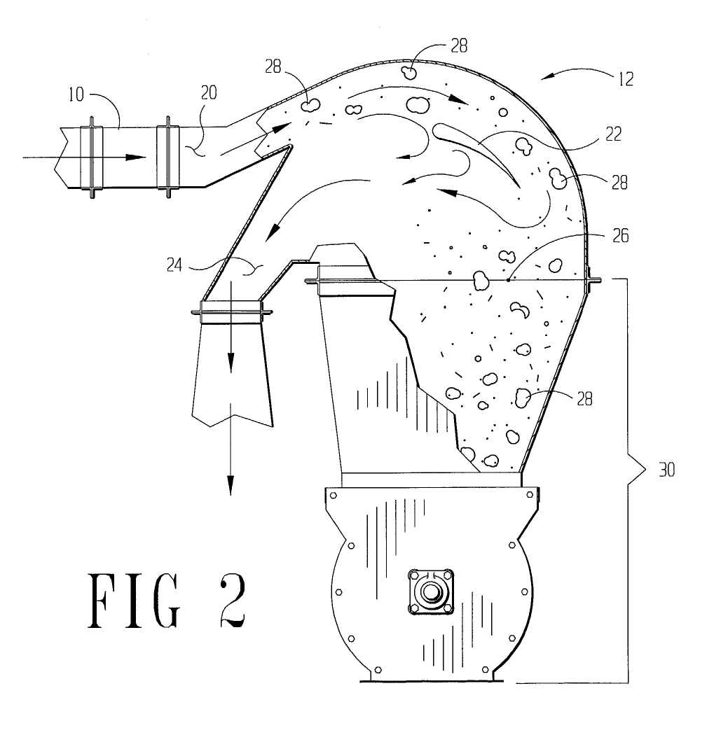

### CATALOG OF ELEMENTS

| | |
|---|---|
| 10 | Air stream duct |
| 12 | Skimmer assembly |
| 20 | Air stream intake |
| 22 | Baffle |
| 24 | Air stream exhaust |
| 26 | Airlock/skimmer interface |
| 28 | Particulate matter |
| 30 | Airlock |
| 32 | Material output duct |
| 40 | Fan assembly |

### DESCRIPTION OF THE PREFERRED EMBODIMENT

Referring to the drawings it may be seen that an air stream carrying particulate matter 28 enters into a chamber 12 through an air stream duct 10. The air stream duct is essentially a suction pipe and is according to the prior art. The air stream passing through the apparatus is generated by the operation of fan assembly 40, which is also according to the prior art. The air stream duct 10 is connected to the chamber 12 by an air stream intake 20. The air stream intake is tapered, decreasing in dimensions as the air stream passes into the chamber 12. The air stream intake 20 is also connected to the chamber 12 tangentially to the curve of the top of the chamber 12. As an air stream passes through this tapered air stream intake 20, the velocity of the air stream and of the particulate matter 28 increases. As the air stream and particulate matter enters the chamber 12, the velocity of the air stream decreases rapidly. Momentum carries the particulate matter 28 around the curved path formed by the top of the chamber 12 and over a baffle 22. This baffle separates the majority of the air stream away from the particulate matter 28. The particulate matter then follows the curved path of the chamber 12 with a small fraction of the air stream and falls through the airlock/skimmer interface 26 and into the airlock 30. The majority of the air stream, however, passes through the air stream exhaust 24 without being accompanied by the particulate matter 28. The air stream is then vented through the fan assembly 40 into the outside environment, while the particulate matter 28 passes through the airlock 30 into an output duct 32. The output duct is according to the prior art and can deposit the particulate matter into any conventional container or storage bin.

The invention claimed is:

1. A method of separating particulate matter from an air stream comprising:
a. passing said air stream through a tapered intake into a chamber which defines a curved path;
b. skimming said particulate matter from said air stream by passing said air stream over a baffle;
c. reversing the direction of said air stream by passing said air stream through an exhaust positioned immediately below the intake for said air stream; and
d. collecting said particulate matter in an airlock located below said chamber.

2. An air stream skimmer comprising:
a. a chamber defined by two side walls connected by a curved top surface wherein said chamber has a bottom opening and a front side;
b. an air stream intake connecting to the upper portion of said front side of said enclosure;
c. an air stream duct connecting to said air stream intake, wherein said air stream duct is larger than said air stream intake;
c. an air stream exhaust connecting to the lower portion of said front side of said enclosure; and
d. a horizontal baffle attached at its ends to said side walls and positioned within said enclosure to the rear of said air stream intake.

3. A method of separating particulate matter from an air stream using the device of claim 2.
